(19) United States
(12) Patent Application Publication
(10) Pub. No.: US 2026/0010798 A1
(43) Pub. Date: Jan. 8, 2026

(54) COMPUTER-READABLE RECORDING MEDIUM, TRAINING METHOD, AND INFORMATION PROCESSING DEVICE

(71) Applicant: Fujitsu Limited, Kawasaki-shi (JP)

(72) Inventors: Hiroo IROBE, Meguro (JP); Wataru AOKI, Meguro (JP); Kimihiro YAMAZAKI, Ohta (JP); Yuhui ZHANG, Meguro (JP); Takumi NAKAGAWA, Meguro (JP); Hiroki WAIDA, Meguro (JP); Yuichiro WADA, Kawasaki (JP); Takafumi KANAMORI, Meguro (JP)

(73) Assignee: Fujitsu Limited, Kawasaki-shi (JP)

(21) Appl. No.: 19/248,831

(22) Filed: Jun. 25, 2025

(30) Foreign Application Priority Data
Jul. 5, 2024 (JP) 2024-109262

(51) Int. Cl. G06N 3/094; G06N 3/0455

(52) U.S. Cl. CPC G06N 3/094; G06N 3/0455

(57) ABSTRACT

A non-transitory computer-readable recording medium stores therein a program that causes a computer to execute a process including receiving training data and noisy training data that is generated by adding noise to the training data, and training a variational autoencoder by applying regularization to reduce a difference between latent representations in a latent space between the training data and the noisy training data corresponding to the training data.

### CROSS-REFERENCE TO RELATED APPLICATION

This application is based upon and claims the benefit of priority of the prior Japanese Patent Application No. 2024-109262, filed on Jul. 5, 2024, the entire contents of which are incorporated herein by reference.

### FIELD

The embodiment discussed herein is related to a computer-readable recording medium, a training method, and an information processing device.

### BACKGROUND

Among generative models, a variational autoencoder (VAE) applied in fields such as image processing and drug discovery is known.

Non Patent Document 1: “Kingma, D. P. and Welling, M. “Auto-encoding variational bayes.” presented in International Conference on Learning Representations 2014” is an example of the related art.

### SUMMARY

According to an aspect of an embodiment, a non-transitory computer-readable recording medium stores therein a training program that causes a computer to execute a process including receiving training data and noisy training data that is generated by adding noise to the training data, and training a variational autoencoder by applying regularization to reduce a difference between latent representations in a latent space between the training data and the noisy training data corresponding to the training data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration example of a server device;

FIG. 2 is a schematic diagram illustrating a network configuration example of a VAE;

FIG. 3 is a diagram (1) illustrating a comparative example of classification accuracy;

FIG. 4 is a diagram (2) illustrating a comparative example of classification accuracy;

FIG. 5 is a diagram (3) illustrating a comparative example of classification accuracy;

FIG. 6 is a diagram (4) illustrating a comparative example of classification accuracy;

FIG. 7 is a diagram (1) illustrating an example of visualization of latent variables;

FIG. 8 is a diagram (2) illustrating an example of visualization of latent variables;

FIG. 9 is a diagram illustrating examples of symbols;

FIG. 10 is a schematic diagram illustrating an example of a training method;

FIG. 11 is a diagram (5) illustrating a comparative example of classification accuracy;

FIG. 12 is a diagram (6) illustrating a comparative example of classification accuracy;

FIG. 13 is a diagram (7) illustrating a comparative example of classification accuracy;

FIG. 14 is a diagram (8) illustrating a comparative example of classification accuracy;

FIG. 15 is a diagram illustrating a comparative example of reconstruction performance;

FIG. 16 is a flowchart illustrating a procedure of training processing; and

FIG. 17 is a diagram illustrating a hardware configuration example.

### DESCRIPTION OF EMBODIMENT

However, the VAE has room for improvement in terms of vulnerability to adversarial inputs.

Preferred embodiments will be explained with reference to accompanying drawings. This embodiment merely illustrates one example or an aspect, and the structure, action, function, property, characteristics, method, application, and the like according to the present disclosure are not limited by such an example. The embodiments can be appropriately combined within a range in which the processing details do not conflict each other.

### First Embodiment

### Overall Configuration

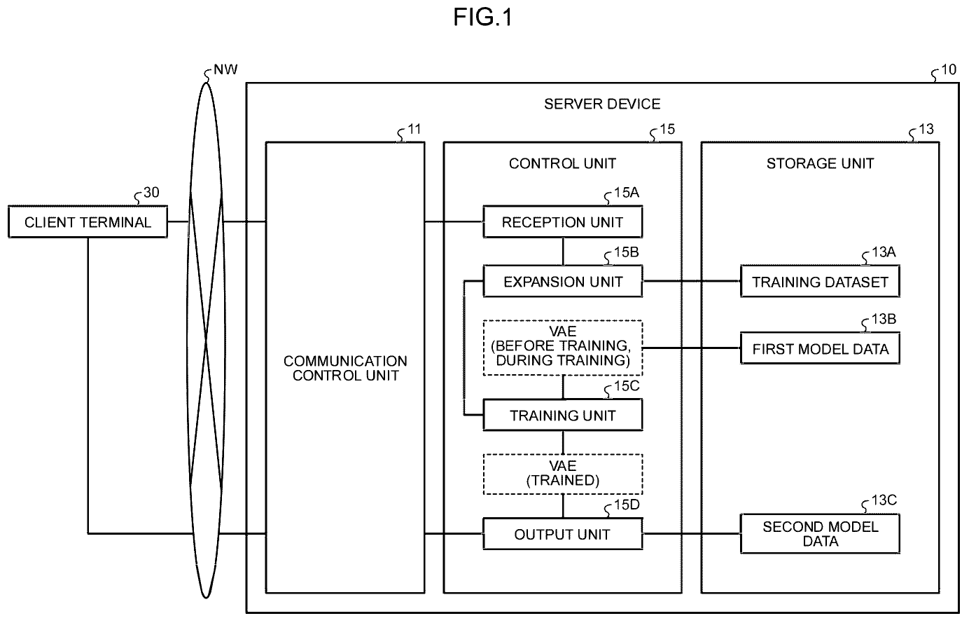

FIG. 1 is a block diagram illustrating a functional configuration example of a server device 10. FIG. 1 illustrates the server device 10 that provides a training function for training a VAE based on a variational lower bound to which regularization is applied to reduce the distance between the latent representations of the original data used to train the VAE and its augmented data within a pair.

The server device 10 can provide the above-described training function as a cloud service by executing middleware based on a platform-as-a-service (PaaS) model or an application based on a software-as-a-service (Saas) model. The server device 10 may be used as an example of the information processing device.

As illustrated in FIG. 1, the server device 10 can be communicatively connected to a client terminal 30 via a network NW. For example, the network NW may be any type of communication network such as the Internet or a local area network (LAN) regardless of whether it is wired or wireless. FIG. 1 illustrates an example in which one client terminal 30 is connected to one server device 10, but connecting any number of client terminals 30 is not restricted.

The client terminal 30 is a terminal device that is provided with the training function. For example, the client terminal 30 can be used by all stakeholders involved in a system that includes a VAE as a component, such as those engaged in system design, development, operation, or maintenance. As an example, the client terminal 30 may be implemented by any computer such as a personal computer, a smartphone, a tablet terminal, or a wearable terminal.

Here, an example in which the training function is provided as a cloud service has been described, but the present disclosure is not limited thereto. For example, the training function may be provided on-premises. An example in which the training function is provided as a client server system has been described, but the present disclosure is not limited thereto. For example, the training function may be provided as a standalone system by causing the client terminal 30 to execute processing corresponding to the training function using an application operating on the client terminal 30.

### VAE

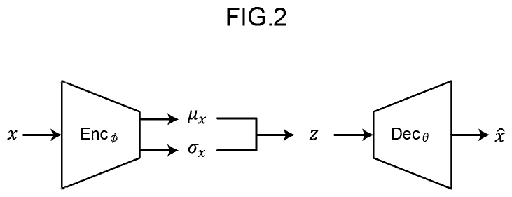

FIG. 2 is a schematic diagram illustrating the network configuration example of the VAE. As illustrated in FIG. 2, the VAE is a kind of generative model having a latent variable z. For example, the VAE may include an encoder Enc_{ϕ} that encodes input data x into the latent variable z and a decoder Dec_{θ} that decodes output data \hat{ }x from the latent variable z.

Here, the encoder Ence may stochastically sample the latent variable z using the mean μₓ and variance σₓ of the multivariate normal distribution with compressed dimensions of the features of input data x. The encoder Enc_{ϕ} may reproduce sampling through approximate computation for calculating the latent variable z using the mean μₓ and the element-wise product of the variance σₓ and ε sampled from the standard normal distribution.

Under such a network configuration, the training of the VAE is implemented by updating parameters θ and ϕ according to Formula (0) reformulated from the problem of maximizing the log-likelihood log p_{θ}(x) to the problem of maximizing the variational lower bound L(θ, ϕ, x).

$${\underbrace{{𝔼}_{{q}_{ϕ} ( z \vert x )} [ log {p}_{θ} ( x \vert z ) ]}}_{Reconstruction error} - {\underbrace{{D}_{K L} [ {q}_{ϕ} ( z \vert x ) \vert \vert p ( z ) ]}}_{Regularization term} \qquad ( 0 )$$

The objective function expressed in Formula (0) includes the first term corresponding to minimization of the reconstruction error and the second term corresponding to regularization of the prior distribution. “q_{ϕ}(z|x)” in Formula (0) refers to a distribution defined by the encoder Enc_{ϕ} when the input data x is given. “p_{θ}(x|z)” in Formula (0) refers to a distribution defined by the decoder Dec_{θ} when the latent variable z is given. “p(z)” in Formula (0) refers to a prior distribution.

### One Aspect of Problem

However, as also described in “Background” section above, the VAE has room for improvement in terms of vulnerability to adversarial inputs.

### Addition of Random Noise

From the aspect of resolving such a problem, methods for generating a VAE with robustness have been proposed. As one of the methods, there is reference technology 1 that experimentally and theoretically indicates a point that noisy data x=x\tilde{ }+ε obtained by adding random noise ε to original data x\tilde{ } improves the robustness of a classifier in supervised learning.

Reference technology 1: Li, B., Chen, C., Wang, W., and Carin, L. (2019). Certified adversarial robustness with additive noise. In Advances in Neural Information Processing Systems, volume 32. Curran Associates, Inc.

### Experiment on Effect of Introducing Robustness

Here, from the aspect of examining whether or not random noise is effective in introducing robustness into the VAE, an experiment will be described in which two trained VAEs (A) and (B) to be described below are compared with the classification accuracy of the encoder. According to the results of such experiments, it is concluded that there is no change in classification accuracy between the VAE (A) and the VAE (B).
(A): VAE trained only on original data x\tilde{ }
(B): VAE trained on both original data x\tilde{ } and noisy data x

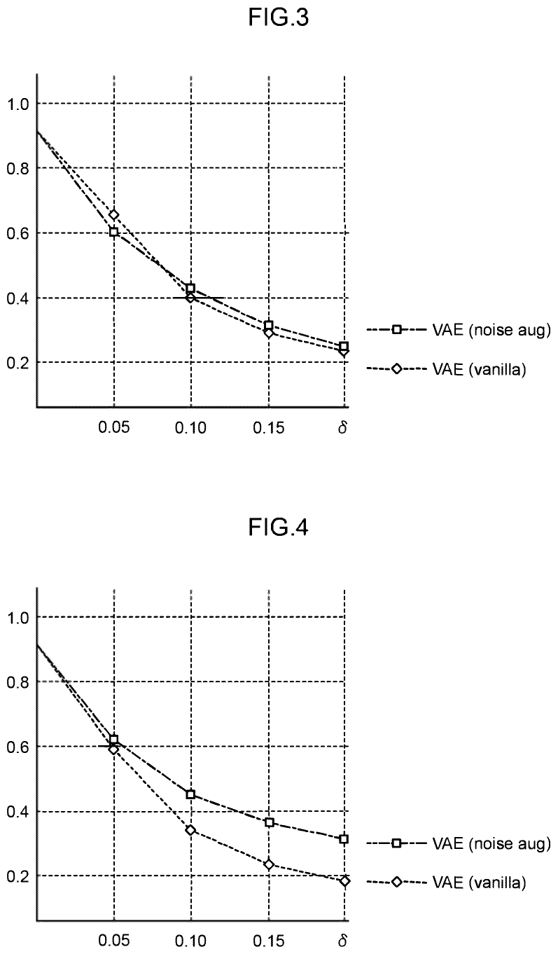

FIGS. 3 to 6 are diagrams (1) to (4) illustrating comparative examples of classification accuracy. FIGS. 3 to 6 illustrate graphs illustrating a relationship between the classification accuracy and the attack radius. In these graphs, the vertical axis represents accuracy and the horizontal axis represents an attack radius δ. In FIGS. 3 to 6, a line graph corresponding to the VAE (A) is represented using a dashed line, and a line graph corresponding to the VAE (B) is represented using a dash-dot line. In FIGS. 3 to 6, a total of four experimental results corresponding to a combination of two types of datasets, MNIST and Fashion-MNIST, along with two metrics used to define the attack radius: Wassersetien distance and KL distance.

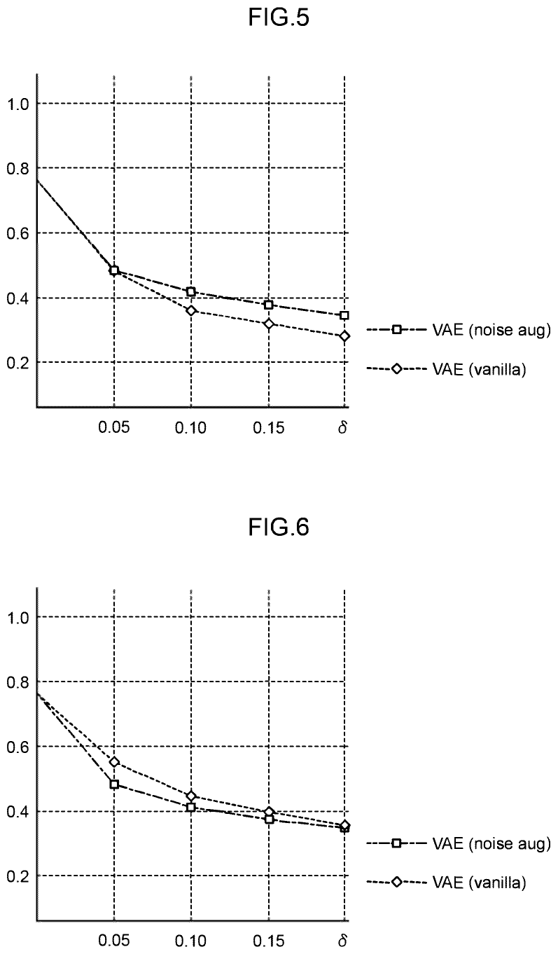

For example, FIG. 3 illustrates the experimental result regarding a combination of MNIST and Wassersetien distance. FIG. 4 illustrates the experimental result regarding a combination of MNIST and KL distance. FIG. 5 illustrates the experimental result regarding a combination of Fashion-MNIST and Wassersetien distance. FIG. 6 illustrates the experimental result regarding a combination of Fashion-MNIST and KL distance.

As an overall conclusion, it is clear that there is no change in the classification accuracy of the VAE (A) and the VAE (B) as illustrated in the line graphs represented using the dashed line and dash-dot line in FIGS. 3 to 6. For example, in the example illustrated in FIG. 3, the classification accuracy of the VAE (B) and the classification accuracy of the VAE (A) decrease equally as the attack radius increases. In the examples illustrated in FIGS. 4 and 5, the decrease in the classification accuracy of the VAE (B) as the attack radius increases is slightly suppressed as compared with the classification accuracy of the VAE (A), but the difference of the decrease in accuracy is not significant. In the example illustrated in FIG. 6, it can be seen that the classification accuracy of the VAE (A) and the classification accuracy of the VAE (B) are reversed, and the classification accuracy of the VAE (B) is lower than the classification accuracy of the VAE (A).

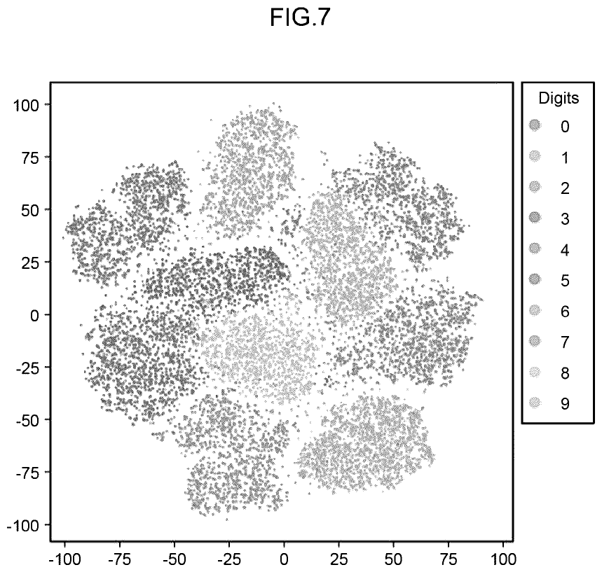

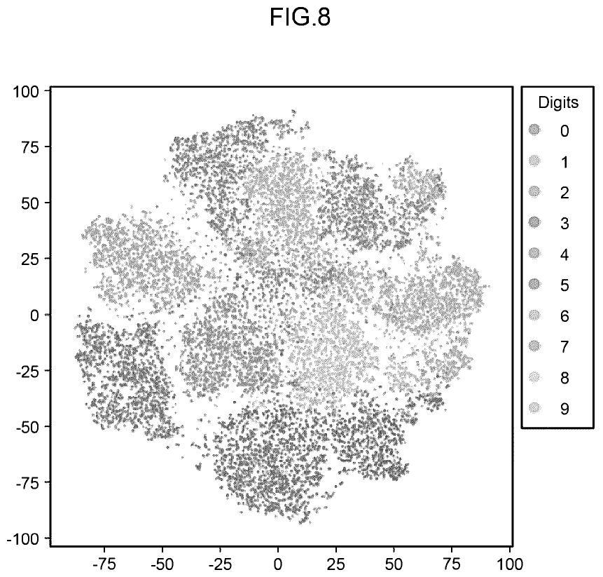

FIGS. 7 and 8 are diagrams (1) and (2) illustrating examples of visualization of the latent variables. In FIGS. 7 and 8, the latent variables are visualized by reducing the dimensionality of the latent variables for MNIST test data output by the encoder of the VAE (A) or the VAE (B) according to t-SNE (Distributed Stochastic Neighbor Embedding). It is assumed that the MNIST test data corresponding to each class label of digits “one” to “nine” is input to the encoder.

Also in the examples illustrated in FIGS. 7 and 8, it is assumed that the VAE (A) is trained only on the original data x\tilde{ } of MNIST, and is trained on both the original data x\tilde{ } and the noisy data x=x\tilde{ }+ε.

For example, the latent variables output from the encoder of the VAE (A) are plotted in FIG. 7, and the latent variables output from the encoder of the VAE (B) are plotted in FIG. 8. As illustrated in FIGS. 7 and 8, the distribution of the latent variables does not change between the VAE (A) and the VAE (B), and conversely, the boundary of the latent variable distribution of each class is unclear in the VAE (B) compared with the VAE (A), and is degraded. In addition, further investigation of the latent variables revealed that the distance //z\tilde{ }−z//₂ between the latent representations (z\tilde{ }, z) of the pair (x\tilde{ }, x) in the VAE (B) was longer compared to the VAE (A). The subsequent “//·//” including the distance //z\tilde{ }−z//₂ may be represented by a norm.

Given that the VAE (B) is also trained on the noisy data x, the behavior is unusual that the distance //z\tilde{ }−z//₂ between the latent representations (z^{\tilde{ }}, z) of the pair (x\tilde{ }, x) in the VAE (B) becomes longer compared to the VAE (A).

### Aspect of Problem-Solving Approach

In the training function according to the present embodiment, under the hypothesis that an increase in the distance //z\tilde{ }−z//₂ hinders the introduction of the robustness of a VAE, regularization to shorten the inter-pair distance //z\tilde{ }−z//₂ is introduced into the variational lower bound of the VAE as illustrated in Equation (1) below.

$$log {p}_{θ} ( \overline{x} ) \geq L ( \overline{x} ; ϕ , θ ) = {\underbrace{{𝔼}_{\overline{z} ∼ {q}_{ϕ} ( \overline{z} \vert \overline{x} )} [ log {p}_{θ} ( \overline{x} \vert \overline{z} ) ]}}_{Reconstruction error} - {\underbrace{{D}_{KL} [ {q}_{ϕ} ( \overline{z} \vert \overline{x} ) \vert \vert p ( \overline{z} ) ]}}_{Regularization term} \qquad ( 1 )$$

### Configuration of Server Device 10

Next, a functional configuration of the server device 10 that provides the above-described training function will be described. FIG. 1 schematically illustrates blocks related to a training function included in the server device 10. As illustrated in FIG. 1, the server device 10 includes a communication control unit 11, a storage unit 13, and a control unit 15. FIG. 1 selectively illustrates only functional units related to the training function, and functional units other than those illustrated may be included in the server device 10.

The communication control unit 11 is a functional unit that controls communication with other devices such as the client terminal 30. As one aspect, the communication control unit 11 can be implemented by a network interface card such as a LAN card. As one aspect, the communication control unit 11 receives a training request for requesting VAE training from the client terminal 30, or outputs a response to the training request to the client terminal 30.

The storage unit 13 is a functional unit that stores various types of data. As one aspect, the storage unit 13 may be implemented by an internal, external, or auxiliary storage of the server device 10. For example, the storage unit 13 stores a training dataset 13A, first model data 13B, and second model data 13C. The training dataset 13A, the first model data 13B, and the second model data 13C will be described later together in a case where reference or registration is executed.

The control unit 15 is a functional unit that performs overall control of the server device 10. For example, the control unit 15 can be implemented by a hardware processor. As illustrated in FIG. 1, the control unit 15 includes a reception unit 15A, an expansion unit 15B, a training unit 15C, and an output unit 15D. The control unit 15 may be implemented by hardwired logic.

The reception unit 15A is a processing unit that receives various types of information from the client terminal 30. As one aspect, the reception unit 15A can receive a training request for requesting training of a VAE from the client terminal 30. When such a training request is received, the specification of a training dataset used for VAE training can be received. For example, the specification of the training dataset can be received from publicly available libraries on the network, or the upload of the training dataset can be received from the client terminal 30. In addition, at the time of receiving the training request, the setting of hyperparameters used for VAE training can also be received.

The expansion unit 15B is a processing unit that augments the training data included in the training dataset 13A. As one aspect, the expansion unit 15B generates a plurality of augmented data points from one original training data by applying data augmentation to the training data included in the training dataset 13A stored in the storage unit 13.

Hereinafter, only an example in which a pair of augmented data points are generated from one original training data will be described. The original training data may be referred to as “original data”.

For example, the expansion unit 15B can generate a pair of augmented data points x−=(x, x′) from the original data x\tilde{ } according to the probability distribution represented by Equation (2) below. “p (x\tilde{ })” in Equation (2) below means the distribution of the original data x\tilde{ }, and “A(·|x\tilde{ })” means the distribution of the augmented data conditioned on x\tilde{ }.

$$\begin{matrix}p ( x , {x}^{′} ) = {𝔼}_{\tilde{x} ∼ p ( \tilde{x} )} [ A ( x \vert \tilde{x} ) A ( {x}^{′} \vert \tilde{x} ) ] \\ = \int A ( x \vert \tilde{x} ) A ( {x}^{′} \vert \tilde{x} ) p ( \tilde{x} ) d \tilde{x}\end{matrix} \qquad ( 2 )$$

Here, the augmentation A(·|x\tilde{ }) described in Equation (2) may refer to general data manipulation to change the original data x\tilde{ } within a range not changing the concept of the original data x\tilde{ }. For example, the augmentation A(·|x\tilde{ }) may include perturbation, for example, addition of noise, and the addition of adversarial perturbation may also be included in the scope. In addition, the augmentation A(·x\tilde{ }) may include rotation, flipping, scaling up, scaling down, and cropping of the original data x\tilde{ }.

The training unit 15C is a processing unit that performs VAE training. As one aspect, the training unit 15C trains the parameters θ and ϕ of the VAE according to the objective function in which regularization for reducing the inter-pair distance //z\tilde{ }−z//₂ is introduced into to the variational lower bound of the VAE, as illustrated in Equation (1).

That is, the variational lower bound of the log-likelihood of the joint distribution x−=(x, x′) is formulated in Equation (1). “z−=(z, z′)” in Equation (1) refers to a latent variable corresponding to x−=(x, x′).

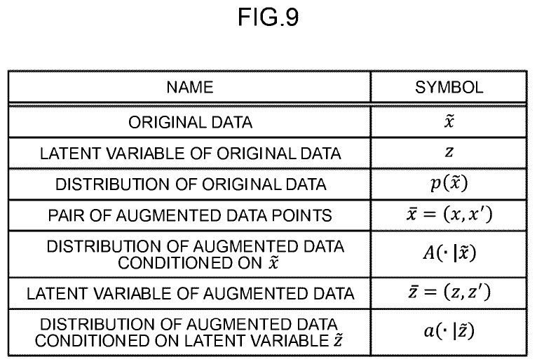

FIG. 9 is a diagram illustrating examples of symbols. FIG. 9 illustrates formal notations of symbols used for the original data, the latent variable of the original data, the distribution of the original data, a pair of the augmented data points, the distribution of the augmented data, and the latent variable of the augmented data. Hereinafter, the notation of the tilde x representing the original data illustrated in FIG. 9 is substituted with “x\tilde{ }”. The notation representing the distribution of the original data illustrated in FIG. 9 is substituted with “p(x\tilde{ })”. The notation representing a pair of augmented data points illustrated in FIG. 9 is substituted with “x−=(x, x′)”. The notation representing the distribution of the augmented data conditioned on the tilde x illustrated in FIG. 9 is substituted with “A(·|x\tilde{ })”, and the notation representing the distribution of the augmented data conditioned on the latent variable tilde z illustrated in FIG. 9 is substituted with “a(·|z\tilde{ })”. The notation representing the latent variable of the augmented data illustrated in FIG. 9 is substituted with “z−=(z, z′)”.

Here, by incorporating a generation process of (z, z′) given in Equation (3) below, the objective function expressed in Equation (1) can be derived in a closed form. “p(z\tilde{ })” in Equation (3) is represented by Equation (3.1) below. “a(z|z\tilde{ })” in Equation (3) is represented by Equation (3.2) below. “a(z′|z\tilde{ })” in Equation (3) is represented by Equation (3.3) below. These Equations (3.1) to (3.3) follow the definition given by Equation (4) below. As illustrated in Equation (4), it is assumed that the random variable z follows a multivariate normal distribution N (z: μ, Σ) of a mean μ and a variance matrix Σ. Hereinafter, this may be referred to as z˜N(μ, Σ).

$$\begin{matrix}p ( \overline{z} ) = {𝔼}_{\tilde{z} ∼ p ( \tilde{z} )} [ a ( z \vert \tilde{z} ) a ( {z}^{′} \vert \tilde{z} ) ] \\ = \int a ( z \vert \tilde{z} ) a ( {z}^{′} \vert \tilde{z} ) p ( \tilde{z} ) d \tilde{z}\end{matrix} \qquad ( 3 )$$

$$p ( \tilde{z} ) = N ( \tilde{z} ; 0 , I ) \qquad ( 3.1 )$$

$$a ( z \vert \tilde{z} ) = N ( z ; \tilde{z} , {Σ}_{aug} ) \qquad ( 3.2 )$$

$$a ( {z}^{′} \vert \tilde{z} ) = N ( {z}^{′} ; \tilde{z} , {Σ}_{aug} ) \qquad ( 3.3 )$$

$$N ( z ; μ , Σ ) = \frac{exp ( - \frac{1}{2} {( z - μ )}^{⊤} {Σ}^{- 1} ( z - μ ) )}{\sqrt{\vert 2 πΣ \vert}} \qquad ( 4 )$$

That is, the prior distribution p(z−) included in the regularization term in Equation (1) can be formulated in a closed form as in Formula (5) below. Specifically, it is assumed that q_{ϕ}(z−|x−) in Equation (1) has the independence illustrated in Equation (6) below, that is, the independence illustrated in Equation (7) below. In this case, the regularization term of Equation (1) can be expressed by Equation (8). Equation (9) and Formula (10) below are assumed. Here, “x\hat{ }=Dec_{θ}(z)” indicated in Formula (10) refers to the reconstruction of the data x, and “w∈R≥0” refers to a weight function, for example, a squared Euclidean distance, cross-entropy, or the like. “R” described above indicates a real number. In this case, Monte Carlo approximation illustrated in Formula (11) below can be applied to the term of the reconstruction error in Equation (1) using one sample from q_{ϕ}(z−|x−).

$$N ( 0 ; z - {z}^{′} , 2 {Σ}_{a u g} ) N ( \frac{z + {z}^{′}}{2} ; 0 , I + \frac{1}{2} {Σ}_{a u g} ) \qquad ( 5 )$$

$${q}_{ϕ} ( \overline{z} \vert \overline{x} ) = {q}_{ϕ} ( z \vert x ) \cdot {q}_{ϕ} ( {z}^{′} \vert {x}^{′} ) \qquad ( 6 )$$

$${q}_{ϕ} ( \overline{z} \vert \overline{x} ) = N ( z ; {μ}_{x} , {Σ}_{x} ) \cdot N ( {z}^{′} ; {μ}_{{x}^{′}} , {Σ}_{{x}^{′}} ) \qquad ( 7 )$$

$$Regularization term = - \frac{1}{4} \{ Tr ( ( {Σ}_{a u g}^{- 1} + {( 2 I + {Σ}_{a u g} )}^{- 1} ) ( {Σ}_{x} + {Σ}_{{x}^{′}} ) ) + {( {μ}_{x} - {μ}_{{x}^{′}} )}^{⊤} {Σ}_{a u g}^{- 1} ( {μ}_{x} - {μ}_{{x}^{′}} ) + {( {μ}_{x} + {μ}_{{x}^{′}} )}^{⊤} {( 2 I + {Σ}_{a u g} )}^{- 1} ( {μ}_{x} + {μ}_{{x}^{′}} ) \} + \frac{1}{2} \{ log \vert {Σ}_{x} \vert + log \vert {Σ}_{{x}^{′}} \vert + 2 d ( 1 - log 2 ) - log \vert {Σ}_{a u g} \vert - log \vert 2 I + {Σ}_{a u g} \vert \} \qquad ( 8 )$$

$${p}_{θ} ( \overline{x} \vert \overline{z} ) = {p}_{ϕ} ( x \vert z ) \cdot {p}_{θ} ( {x}^{′} \vert {z}^{′} ) \qquad ( 9 )$$

$${p}_{θ} ( x \vert z ) ∝ exp ( - w ( x , \hat{x} ) ) \qquad ( 10 )$$

$$Reconstruction error \approx - w ( x , \hat{x} ) - w ( {x}^{′} , {\hat{x}}^{′} ) + constant \qquad ( 11 )$$

In this manner, Formula (11) can be derived as the first term corresponding to the reconstruction error, and Equation (8) can be derived as the second term corresponding to the regularization term in the objective function expressed in Equation (1).

From the above, since the objective function expressed in Equation (1) can be formulated in a closed form, it is possible to train a VAE using an objective function that is easily computed by a computer.

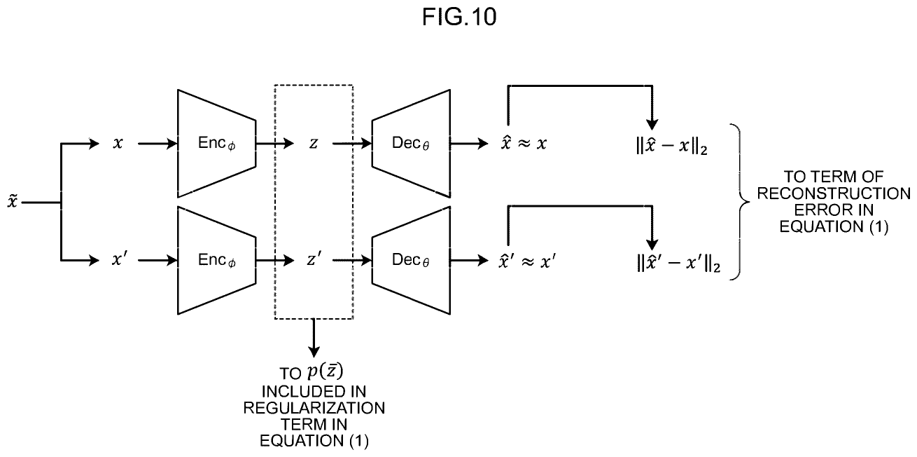

The training of the VAE using such an objective function will be specifically described. FIG. 10 is a schematic diagram illustrating an example of a training method. As illustrated in FIG. 10, when a pair of augmented data points x−= (x, x′) are generated from the original data x\tilde{ }, the training unit 15C inputs the augmented data x and the augmented data x′, which are included in the pair x−, to the encoders Ence of the VAE, respectively. The encoder Ence and the decoder Dec_{ϕ} of the VAE can start training using the initial values of the parameter θ and parameter ϕ stored as the first model data in the storage unit 13.

For example, in a case where the augmented data x is input to the VAE, the encoder Enc_{ϕ} to which the augmented data x is input outputs the latent variable z. Thereafter, the decoding Dec_{θ} to which the latent variable z is input outputs the reconstructed x\hat{ }. On the other hand, in a case where the augmented data x′ is input to the VAE, the encoder Ence to which the augmented data x′ is input outputs the latent variable z′. Thereafter, the decoding Dec_{θ} to which the latent variable z′ is input outputs the reconstructed x\hat{ }′.

Under such a behavior of the VAE, the training unit 15C calculates the reconstruction error //x\hat{ }−x//₂ in the augmented data x and the reconstruction error//x\hat{ }′−x′//₂ in the augmented data x′, and substitutes these two reconstruction errors into the term of the reconstruction error in Equation (1). The training unit 15C substitutes the latent variable z and the latent variable z′ into the regularization term in Equation (1). Then, the training unit 15C updates the objective function expressed in Equation (1), that is, the parameters θ and ϕ of the VAE that maximizes the variational lower bound.

The output unit 15D is a processing unit that executes output control for the client terminal 30. As one aspect, the output unit 15D can output the trained VAE generated by the training unit 15C to the client terminal 30 as a response to the training request received by the reception unit 15A. Hereinafter, the VAE trained by the training function according to the present embodiment may be referred to as a “Robust Augmented Variational Auto-ENcoder (RAVEN)”. As one aspect, the output unit 15D can also store data regarding RAVEN generated by the training unit 15C, for example, a layer structure of the VAE, the parameters θ and ϕ, and the like in the storage unit 13 as second model data.

### Robustness of VAE by Training Function

Next, the robustness of the RAVEN according to the present embodiment will be described while performing performance comparison. The “robustness” described here may be evaluated from two aspects: the classification accuracy of the encoder and the overall reconstruction error of the encoder and decoder.

Hereinafter, performance comparison is performed among the RAVEN according to the present embodiment, the VAE (A) trained only on the original data x\tilde{ }, the VAE (B) trained on both the original data x\tilde{ } and the noisy data x, and a VAE (SE) trained by a smooth encoder (SE) to be described below.

### Reference Technology 2

That is, reference technology 2 experimentally finds that the VAE is not robust to inputs outside the support of the empirical distribution, and proposes the SE in order to resolve this vulnerability problem.

Reference technology 2: Cemgil, T., Ghaisas, S., Dvijotham, K. D., and Kohli, P. (2020b). Adversarially robust representations with smooth encoders. In International Conference on Learning Representations

That is, in reference technology 2, the autoencoder is trained by maximizing the modified variational lower bound for the log-likelihood of the marginal distribution p_{θ}(x). Here, p_{θ}(x) is expressed as ∫p_{θ}(x, x′)dx′. x and x′ are the original data and the adversarial data corresponding to the original data. For example, the adversarial data may be configured by user definition. x′ is constructed from x using KL divergence and Wasserstein distance, or the like. The joint distribution p_{θ}(x, x′) is defined using Formula (12) below. A “function c” in Formula (12) is a function exemplified in Equation (13) below, and “γ” in Formula (12) is a positive hyperparameter.

$$\int {p}_{θ} ( x \vert z ) {p}_{θ} ( {x}^{′} \vert {z}^{′} ) exp ( - \frac{γ}{2} c ( z , {z}^{′} ) ) p ( z ) p ( {z}^{′} ) {dzdz}^{′} \qquad ( 12 )$$

$$c ( z , {z}^{′} ) = \vert \vert z - {z}^{′} {\vert \vert}_{2}^{2} \qquad ( 13 )$$

The training function according to the present embodiment and the SE described above have an obvious difference in terms of the following description. That is, in the SE, the variational lower bound is based on a marginal distribution derived using adversarial data, and the adversarial data is usually outside the support of the empirical distribution. On the other hand, the variational lower bound used in the training function according to the present embodiment is based on the joint distribution p_{θ} (x, x′), and x and x′ are defined as augmented data constructed from the original data x\tilde{ }.

### Performance Comparison

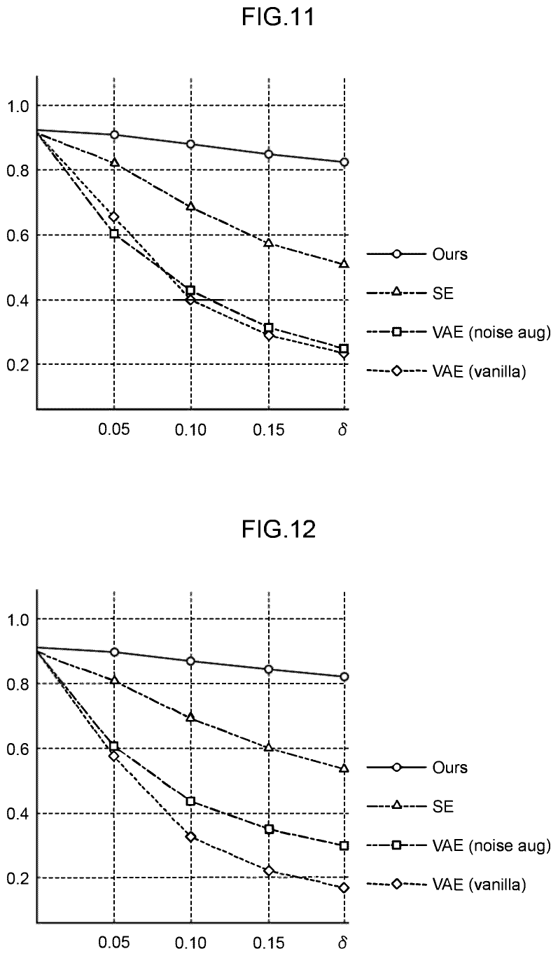

FIGS. 11 to 14 are diagrams (5) to (8) illustrating comparative examples of classification accuracy. FIGS. 11 to 14 illustrate graphs illustrating a relationship between the classification accuracy and the attack radius. In these graphs, the vertical axis represents accuracy and the horizontal axis represents an attack radius δ. In FIGS. 11 to 14, a line graph corresponding to the VAE (A) is represented using a dashed line, a line graph corresponding to the VAE (B) is represented using a dash-dot line, a line graph corresponding to the VAE (SE) is represented using a double dash-dot line, and a line graph corresponding to the RAVEN is represented using a solid line.

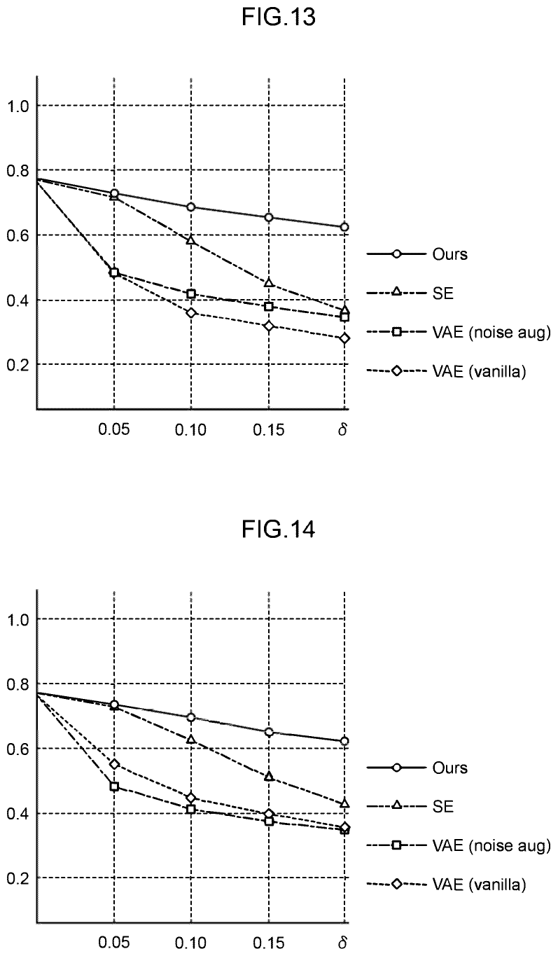

In FIGS. 11 to 14, a total of four experimental results corresponding to a combination of two types of datasets, MNIST and Fashion-MNIST, along with two metrics used to define the attack radius: Wassersetien distance and KL distance. For example, FIG. 11 illustrates the experimental result regarding a combination of MNIST and Wassersetien distance. FIG. 12 illustrates the experimental result regarding a combination of MNIST and KL distance. FIG. 13 illustrates the experimental result regarding a combination of Fashion-MNIST and Wassersetien distance. FIG. 14 illustrates the experimental result regarding a combination of Fashion-MNIST and KL distance.

Here, the adversarial input used to compare the performance of the VAE (A), the VAE (B), the VAE (SE), and the RAVEN may be implemented by adding an adversarial perturbation ε_{adv} illustrated in Equation (14) below to the original data. “Δ” in Equation (14) is defined by KL divergence, Wesserstein distance, and the like.

$${ε}_{a d v} = {arg max}_{\vert \vert ε \vert \vert \leq δ} Δ [ {q}_{ϕ} ( \cdot \vert x ) \vert {q}_{ϕ} ( \cdot \vert x + ε ) ] \qquad ( 14 )$$

The hyperparameter of RAVEN may be configured as follows. For example, two augmented data points (x, x′) in Equation (2) are defined by (x\tilde{ }, x\tilde{ }+ε). Here, ε follows N (0,0.05²I). For the variance matrix Σ_{aug}, 0.04²I and 0.01²I are defined for MNIST and Fashion-MNIST, respectively. The weight function w in Formula (11) is defined by cross-entropy.

Under the condition described above, when the classification accuracy of the VAE (A), the VAE (B), the VAE (SE), and the RAVEN is compared, the results illustrated in FIGS. 11 to 14 are obtained. As illustrated in FIGS. 11 to 14, it is obvious that the classification accuracy of the RAVEN according to the present embodiment is higher than that of the VAE (A), the VAE (B), and the VAE (SE). That is, regardless of the image dataset used for testing and the metric of the distance used for defining the attack, the decrease in accuracy of the RAVEN due to the increase in the attack radius is suppressed as compared with the VAE (A), the VAE (B), and the VAE (SE) in all aspects of the total of four patterns.

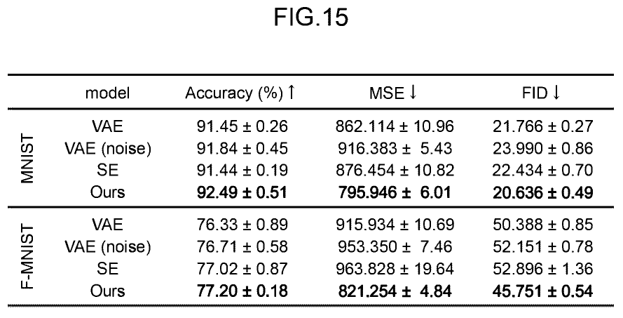

Next, the presence or absence of side effects of the RAVEN according to the present embodiment will be described. FIG. 15 illustrates the classification accuracy of each of the VAE (A), the VAE (B), the VAE (SE), and the RAVEN, and the mean and standard deviation of five experimental results for Mean Squared Error (MSE) and Fre'chet Inception Distance (FID) in a table format. “e′” in “Fre'chet” may be a substitute for the notation of e with an acute accent. In FIG. 15, the best results for each evaluation metric of the classification accuracy, the MSE, and the FID are illustrated in bold. As the value of the classification accuracy, the value of attack radius δ=0 illustrated in FIGS. 3 to 6 is rewritten. As illustrated in FIG. 15, it is obvious that the RAVEN evaluation according to the present embodiment is the best in both the MSE and the FID.

As described above, since the reconstruction error is minimal in a case where attack radius δ=0, it is obvious that there is no side effect in the training function according to the present embodiment. According to the RAVEN according to the present embodiment, since the side effects do not occur at the time of training and the improvement in the classification accuracy is obvious, it can be expected that the reconstruction error is minimized.

### Flow of Processing

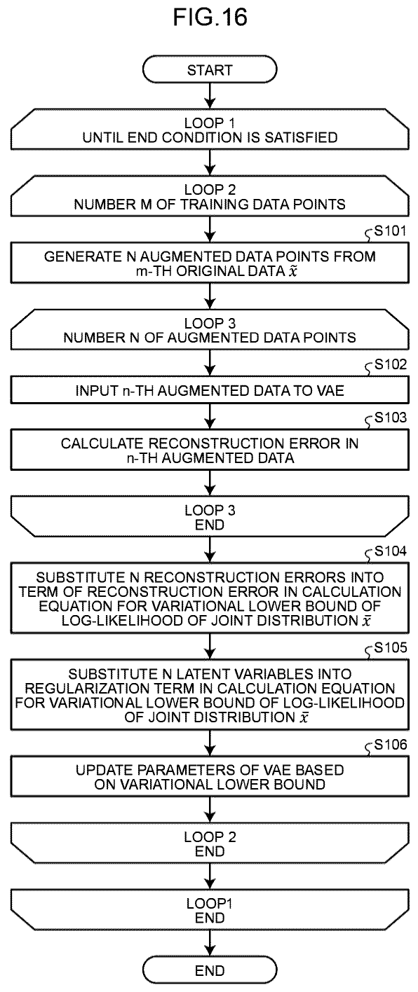

Next, a flow of processing of the server device 10 according to the present embodiment will be described. FIG. 16 is a flowchart illustrating a procedure of training processing. Only as an example, this processing is started in a case where a training request for requesting training of the VAE is received from the client terminal 30.

As illustrated in FIG. 16, processing from Step S101 to Step S106 is repeated as loop processing 1 until a condition such as an end condition is satisfied, for example, where the prescribed number of epochs has been executed or parameters θ and ϕ reach convergence based on a prescribed learning rate.

The processing from Step S101 to Step S106 is repeated as loop processing 2 by the number of times corresponding to the total number M of training data points included in the training dataset 13A per epoch.

That is, the expansion unit 15B generates N augmented data points from the m-th original data (Step S101). Here, only as an example, N=2 is given, but N may be any natural number.

Subsequently, the processing in Step S102 and Step S103 is repeated as loop processing 3 by the number of times corresponding to the number N of augmented data points.

That is, the training unit 15C inputs the n-th augmented data to the encoder Ence of the VAE (Step S102). Then, the training unit 15C calculates a reconstruction error in the n-th augmented data (Step S103).

By repeating the loop processing 3, a parameter to be substituted into the term of the reconstruction error in Equation (1) is derived. For example, in a case where two augmented data points x and x′ are generated, the reconstruction error //x\hat{ }−x//₂ in the augmented data x and the reconstruction error //x\hat{ }′−x′//₂ in the augmented data x′ are calculated.

Thereafter, the training unit 15C substitutes N reconstruction errors calculated in Step S103 into the first term corresponding to the term of the reconstruction error in Equation (1) (Step S104). The training unit 15C substitutes the latent variable output by the encoder for every N augmented data points as a result of Step S102 into the regularization term in Equation (1) (Step S105).

Then, the training unit 15C updates the objective function expressed in Equation (1), that is, the parameters θ and ϕ of the VAE that maximizes the variational lower bound (Step S106).

By repeating the loop processing 2, one epoch of the VAE training is performed. By repeating the loop processing 1, convergence of the parameters θ and ϕ of the VAE is realized.

### One Aspect of Effect

As described above, the server device 10 according to the present embodiment trains a VAE based on the variational lower bound to which the regularization is applied to reduce the distance between the latent representations of the original data used to train the VAE and its augmented data within a pair. Therefore, the server device 10 according to the present embodiment can achieve enhanced robustness of the variational autoencoder against adversarial inputs.

### Second Embodiment

Although the embodiment of the present disclosure have been described so far, various applications are possible, and furthermore, embodiments other than the above-described embodiments may be implemented in various different forms.

### Exertion of Creativity

The matters described in the above embodiment, for example, specific examples such as the first term and the second term of the variational lower bound are merely examples, and can be changed. Also in the flowcharts described in the embodiments, the order of processing can be changed within a range without a conflict.

### Application Example of Regularization Term

In the first embodiment described above, an example has been described in which the prior distribution of the regularization term included in the variational lower bound illustrated in Equation (1) is formulated by the normal distribution, but the present disclosure is not limited thereto. For example, the prior distribution of the regularization term can also be formulated based on a Gaussian mixture model (GMM).

For example, the prior distribution p_{Ψ}(z\tilde{ }) can be represented by Equation (15) below. In this case, the parameter Ψ illustrated in Equation (16) below is trained. Here, “μ_{c}” and “Σ_{c}” illustrated in Equation (16) represent the mean and variance of the c-th Gaussian distribution, and “π_{c}” represents the weight of the c-th Gaussian distribution and is expressed by, for example, Equation (17) below. Based on these, the prior distribution p_{Ψ}(z\tilde{ }) can be expressed as illustrated in Formula (18). When Equation (15) is applied to Equation (1), Equation (1) can be expressed as illustrated in Equation (19).

$${p}_{ψ} ( \tilde{z} ) = {Σ}_{c = 1}^{C} {π}_{c} N ( \tilde{z} ; {μ}_{c} , {Σ}_{c} ) \qquad ( 15 )$$

$$ψ = {\{ ( {π}_{c} , {μ}_{c} , {Σ}_{c} ) \}}_{c = 1}^{C} \qquad ( 16 )$$

$${π}_{c} ∈ [ 0 , 1 ] , {Σ}_{c = 1}^{C} {π}_{c} = 1 \qquad ( 17 )$$

$$N ( 0 ; z - {z}^{′} , 2 {Σ}_{a u g} ) {\sum }_{c = 1}^{C} {π}_{c} N ( \frac{z + {z}^{′}}{2} ; {μ}_{c} , {Σ}_{c} + \frac{1}{2} {Σ}_{a u g} ) \qquad ( 18 )$$

$$L ( \overline{x} ; ϕ , θ ) = {𝔼}_{{q}_{ϕ} ( \overline{z} \vert \overline{x} )} [ log {p}_{θ} ( \overline{x} \vert \overline{z} ) ] + {𝔼}_{{q}_{ϕ} ( \overline{z} \vert \overline{x} )} [ log {\sum }_{c = 1}^{C} {π}_{c} N ( \frac{z + {z}^{′}}{2} ; {μ}_{c} , {Σ}_{c} + \frac{1}{2} {Σ}_{a u g} ) ] - \frac{1}{4} ( Tr ( {Σ}_{aug}^{- 1} ( {Σ}_{x} + {Σ}_{{x}^{′}} ) ) + {( {μ}_{x} - {μ}_{{x}^{′}} )}^{⊤} {Σ}_{aug}^{- 1} ( {μ}_{x} - {μ}_{{x}^{′}} ) ) + \frac{1}{2} ( log \vert {Σ}_{x} \vert + log \vert {Σ}_{{x}^{′}} \vert ) + ( d + \frac{d}{2} log π - \frac{1}{2} log \vert {Σ}_{a u g} \vert ) \qquad ( 19 )$$

### System

The processing procedure, the control procedure, the specific name, and the information including various types of data and parameters, which are illustrated in the document and the drawings, can be arbitrarily changed unless otherwise specified. For example, one or more functional units among the reception unit 15A, the expansion unit 15B, the training unit 15C, and the output unit 15D, which are included in the server device 10, may be configured in separate devices.

Each component of each device illustrated in the drawings is functionally conceptual, and is not necessarily physically configured as illustrated in the drawings. That is, specific forms of distribution and integration of the devices are not limited to those illustrated in the drawings. That is, all or a part thereof can be functionally or physically distributed and integrated in an arbitrary unit according to various loads, usage conditions, and the like. Each configuration may be a physical configuration.

All or any part of the processing functions performed in each device can be implemented by a central processing unit (CPU) and a program analyzed and executed by the CPU, or can be implemented as hardware using wired logic.

### Hardware

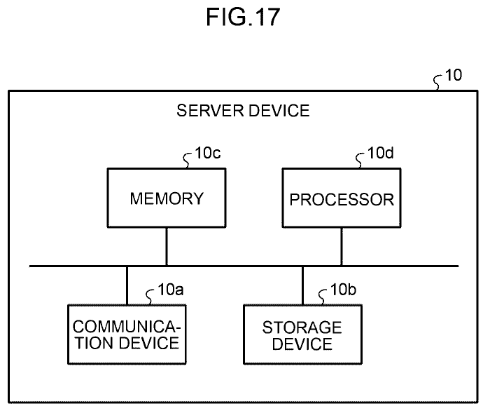

Next, a hardware configuration example of the computer described in the embodiment will be described. FIG. 17 is a diagram illustrating the hardware configuration example. As illustrated in FIG. 17, the server device 10 includes a communication device 10a, a storage device 10b, a memory 10c, and a processor 10d. The units illustrated in FIG. 17 may be connected to each other by a bus.

The communication device 10a is a network interface card. The storage device 10b is a storage device such as a hard disk drive (HDD) or a solid state drive (SSD). For example, the storage device 10b stores a program for operating the functions illustrated in FIG. 1, a DB, and the like.

The processor 10d reads a program for executing processing similar to the processing unit illustrated in FIG. 1 from the storage device 10b and loads the program into the memory 10c, and operates the process for executing the functions described with reference to FIG. 1.

Such a process implements a function similar to that of the processing unit included in the server device 10. For example, the processor 10d reads a program having functions similar to those of the reception unit 15A, the expansion unit 15B, the training unit 15C, the output unit 15D from the storage device 10b. The processor 10d executes a process of executing processing similar to those of the reception unit 15A, the expansion unit 15B, the training unit 15C, and the output unit 15D.

In this manner, the server device 10 operates as an information processing device that executes the training method by reading and executing the program. The server device 10 can also implement functions similar to those of the above-described embodiment by reading the program from the recording medium by means of the medium reading device and executing the read program. The program described in other embodiments is not limited to being executed by the server device 10. For example, the present invention can be similarly applied to a case where another computer or server executes a program or a case where these execute a program in cooperation.

The program can be distributed via a network such as the Internet. The program can be executed by being recorded in an arbitrary recording medium and being read from the recording medium by the computer. For example, the recording medium can be realized by a hard disk, a flexible disk (FD), a CD-ROM, a magneto-optical disk (MO), a digital versatile disc (DVD), or the like.

According to the embodiment, it is possible to achieve enhanced robustness of the variational autoencoder against adversarial inputs.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a training program that causes a computer to execute a process comprising:
receiving training data and noisy training data that is generated by adding noise to the training data; and
training a variational autoencoder by applying regularization to reduce a difference between latent representations in a latent space between the training data and the noisy training data corresponding to the training data.

2. The non-transitory computer-readable recording medium according to claim 1, wherein the process further includes generating a pair of the noisy training data from the training data, and
the training includes applying the regularization to reduce a difference between the latent representations in the latent space to a variational lower bound of log-likelihood of a joint distribution related to the pair of the noisy training data.

3. The non-transitory computer-readable recording medium according to claim 2, wherein a prior distribution of regularization terms included in the variational lower bound is formulated based on a normal distribution.

4. The non-transitory computer-readable recording medium according to claim 2, wherein a prior distribution of regularization terms included in the variational lower bound is formulated based on a Gaussian mixture model.

5. A training method comprising:
receiving training data and noisy training data that is generated by adding noise to the training data; and
training a variational autoencoder by applying regularization to reduce a difference between latent representations in a latent space between the training data and the noisy training data corresponding to the training data, by a processor.

6. The training method according to claim 5, further including generating a pair of the noisy training data from the training data, wherein
the training includes applying the regularization to reduce a difference between the latent representations in the latent space to a variational lower bound of log-likelihood of a joint distribution related to the pair of the noisy training data.

7. The training method according to claim 6, wherein a prior distribution of regularization terms included in the variational lower bound is formulated based on a normal distribution.

8. The training method according to claim 6, wherein a prior distribution of regularization terms included in the variational lower bound is formulated based on a Gaussian mixture model.

9. An information processing device comprising:
a processor configured to:
receive training data and noisy training data that is generated by adding noise to the training data; and
apply regularization to reduce a difference between latent representations in a latent space between the training data and the noisy training data corresponding to the training data.

10. The information processing device according to claim 9, wherein the processor is further configured to:
generate a pair of the noisy training data from the training data; and
apply the regularization to reduce a difference between the latent representations in the latent space to a variational lower bound of log-likelihood of a joint distribution related to the pair of the noisy training data.

11. The information processing device according to claim 10, wherein a prior distribution of regularization terms included in the variational lower bound is formulated based on a normal distribution.

12. The information processing device according to claim 10, wherein a prior distribution of regularization terms included in the variational lower bound is formulated based on a Gaussian mixture model.
